(19) United States
(12) Patent Application Publication
(10) Pub. No.: US 2018/0252243 A1
(43) Pub. Date: Sep. 6, 2018

(54) SYSTEMS AND METHODS FOR DYNAMIC RESPONSE ON MOBILE MACHINES

(71) Applicant: HUSCO INTERNATIONAL, INC., Waukesha, WI (US)

(72) Inventors: Joseph L. Pfaff, Wauwatosa, WI (US); Benjamin D. Holter, New Berlin, WI (US); Eric P. Hamkins, Waukesha, WI (US)

(21) Appl. No.: 15/912,285

(22) Filed: Mar. 5, 2018

Related U.S. Application Data
(60) Provisional application No. 62/466,618, filed on Mar. 3, 2017.
(60) Provisional application No. 62/466,643, filed on Mar. 3, 2017.
(60) Provisional application No. 62/466,661, filed on Mar. 3, 2017.

(51) Int. Cl. F15B 13/16; F15B 13/02; E02F 9/22

(52) U.S. Cl. CPC F15B 13/16; F15B 13/021; F15B 13/027; E02F 9/2228; E02F 9/2296; E02F 9/2217; F15B 2211/205; F15B 2201/00; E02F 9/2292; E02F 9/2267

(57) ABSTRACT

The present disclosure provides a control valve assembly arranged between a main control valve and a hydraulic function on a mobile machine. The control valve assembly includes a fluid source, a first supply valve, a first return valve, a second supply valve, and a second return valve. The control valve assembly further includes a controller configured to determine if an actual motion parameter of the hydraulic function is different than a desired motion parameter based on the determination of a motion sensor. The controller configured to selectively move at least one of the first supply valve, the first return valve, the second supply valve, and the second return valve to adjust the actual motion parameter of the hydraulic function and compensate for a difference between the actual motion parameter and the desired motion parameter.

### CROSS-REFERENCES TO RELATED APPLICATIONS

The present application is based on and claims priority to U.S. Provisional Patent Application No. 62/466,618, filed on Mar. 3, 2017, U.S. Provisional Patent Application No. 62/466,643, filed on Mar. 3, 2017, and U.S. Provisional Patent Application No. 62/466,661, filed on Mar. 3, 2017. All of which are incorporated herein by reference.

### STATEMENT REGARDING FEDERALLY SPONSORED RESEARCH

Not Applicable.

### BACKGROUND

Currently, there is a trend to develop automation on mobile machinery. For example, the movement and placement of a control arm on an excavator may be automated to perform a desired task. During operation, the control arm on an excavator has mechanical compliance in addition to hydraulic compliance. These compliance characteristics can make precise position/velocity control more difficult and limits the value an automation system can achieve. The compliance characteristics not only can limit precision, but also may limit the stability of the system, since without appreciable damping of the system the mechanical structure and hydraulics can react in an undesired way to disturbances.

Conventional hydraulic systems used on excavators can be optimized to the expectations of the operator and respond successfully within the bandwidth expected by the operator. For electrohydraulic systems, automation control desires to have higher bandwidth than an operators expectations, in addition to levels of precision beyond what existing hydraulic systems can provide. With conventional systems, there can be a high level of connected states including engine speed and torque, pump pressure and flow, spool position and associated throttling losses, hose compliance states in the pump, and workports in addition to the kinematic states of the excavator structure. All of these states are connected in conventional systems both dynamically and quasi-statically into an optimized system around the operators control bandwidth and expectations. However, conventional systems are difficult to optimize around the goals of an electrohydraulic system due to the fundamentally different needs. For example, an electrohydraulic automation system requires higher levels of stiffness, response bandwidth, and velocity precision, to name a few, while also having less coupled dependence on the state of the engine, pump, and scope of states in the main control valve and associated workport hoses.

### BRIEF SUMMARY

In some aspects, the present disclosure provides a control valve assembly arranged between a main control valve and a hydraulic function on a mobile machine. The hydraulic function includes a first workport and a second workport. The control valve assembly includes a fluid source, a first supply valve configured to selectively provide fluid communication between the fluid source and the first workport, a first return valve configured to selectively provide fluid communication between the first workport and a reservoir, a second supply valve configured to selectively provide fluid communication between the fluid source and the second workport, and a second return valve configured to selectively provide fluid communication between the second workport and the reservoir. The control valve assembly further includes a motion sensor configured to determine a motion parameter of the hydraulic function, and a controller in communication with the first supply valve, the first return valve, the second supply valve, the second return valve, and the motion sensor. The controller is configured to determine if an actual motion parameter of the hydraulic function is different than a desired motion parameter based on the determination of the motion sensor, and selectively move at least one of the first supply valve, the first return valve, the second supply valve, and the second return valve to adjust the actual motion parameter of the hydraulic function and compensate for a difference between the actual motion parameter and the desired motion parameter.

In some aspects, the present disclosure provides a control valve assembly arranged between a main control valve and a hydraulic function on a mobile machine. The hydraulic function includes a first workport and a second workport. The control valve assembly includes a fluid source, a first supply valve configured to selectively provide fluid communication between the fluid source and the first workport, a first return valve configured to selectively provide fluid communication between the first workport and a reservoir, a second supply valve configured to selectively provide fluid communication between the fluid source and the second workport, and a second return valve configured to selectively provide fluid communication between the second workport and the reservoir. The control valve assembly further includes a motion sensor configured to determine a motion parameter of the hydraulic function, a first pressure sensor configured to measure a pressure at the first workport, a second pressure sensor configured to measure a pressure at the second workport, and a controller in communication with the first supply valve, the first return valve, the second supply valve, the second return valve, the first pressure sensor, the second pressure sensor, and the motion sensor. The controller is configured to move at least one of the first supply valve and the first return valve to achieve a pressure at the first workport within a predetermined tolerance of a target first workport pressure, and move at least one of the second supply valve and the second return valve to achieve a pressure at the second workport within a predetermined tolerance of a target second workport pressure. The target first pressure and the target second pressure corresponding with a desired motion parameter of the hydraulic function.

In some aspects, the present disclosure provides a control valve assembly arranged between a main control valve and a hydraulic function on a mobile machine. The hydraulic function includes a first workport and a second workport. The control valve assembly includes a fluid source, a first supply valve configured to selectively provide fluid communication between the fluid source and the first workport, a first return valve configured to selectively provide fluid communication between the first workport and a reservoir, a second supply valve configured to selectively provide fluid communication between the fluid source and the second workport, and a second return valve configured to selectively provide fluid communication between the second workport and the reservoir. The control valve assembly further includes a motion sensor configured to measure a position of the hydraulic function, a first pressure sensor configured to measure a pressure at the first workport, a second pressure sensor configured to measure a pressure at the second workport, and a controller in communication with the first supply valve, the first return valve, the second supply valve, the second return valve, the first pressure sensor, the second pressure sensor, and the motion sensor. The controller is configured to instruct one of the first supply valve and the second supply valve to pressurize a corresponding one of the first workport and the second workport to a predetermined system pressure via the fluid source, and control a pressure at the other of the first workport and the second workport to a predetermined pressure below the predetermined system pressure via at least one of the first supply valve, the first return valve, the second supply valve, and the second return valve. The predetermined pressure corresponding with a desired motion parameter of the hydraulic function.

In some aspects, the present disclosure provides a method for controlling a hydraulic function on a mobile machine. The mobile machine including a main control valve configured to manipulate the hydraulic function. The hydraulic function including a first workport and a second workport. The method includes hydraulically coupling a control valve assembly between the main control valve and the hydraulic function. The control valve assembly configured to selectively provide pressurized fluid to at least one of the first workport and the second workport and to selectively connect at least one of the first workport and the second workport to a reservoir. The method further includes commanding the hydraulic function, via the main control valve, to a desired motion parameter, determining if an actual motion parameter of the hydraulic function is different than the desired motion parameter, and upon determining that the actual motion parameter is different than the desired motion parameter, adjusting the hydraulic function, via the control valve assembly, to bring the actual motion parameter within a predetermined tolerance of the desired motion parameter.

In some aspects, the present disclosure provides a method for controlling a hydraulic function on a mobile machine. The mobile machine including a main control valve configured to manipulate the hydraulic function. The hydraulic function including a first workport and a second workport. The method includes hydraulically coupling a control valve assembly between the main control valve and the hydraulic function. The control valve assembly configured to selectively provide pressurized fluid to at least one of the first workport and the second workport and to selectively connect at least one of the first workport and the second workport to a reservoir. The method further includes pressurizing, via the control valve assembly, at least one of the first workport and the second workport to a predetermined system pressure, and controlling a desired motion parameter of the hydraulic actuation by adjusting a pressure at the other of the first workport and the second workport, via the control valve assembly, to a predetermined pressure below the predetermined system pressure.

The foregoing and other aspects and advantages of the disclosure will appear from the following description. In the description, reference is made to the accompanying drawings which form a part hereof, and in which there is shown by way of illustration a preferred configuration of the disclosure. Such configuration does not necessarily represent the full scope of the disclosure, however, and reference is made therefore to the claims and herein for interpreting the scope of the disclosure.

### BRIEF DESCRIPTION OF DRAWINGS

The invention will be better understood and features, aspects and advantages other than those set forth above will become apparent when consideration is given to the following detailed description thereof. Such detailed description makes reference to the following drawings.

FIG. 1 is a schematic illustration of a hydraulic circuit including a control valve assembly according to one aspect of the present disclosure.

FIG. 2 is a schematic illustration of a hydraulic circuit including a control valve assembly with a regeneration path through a first and second supply valve according to one aspect of the present disclosure.

FIG. 3 is a schematic illustration of a hydraulic circuit including a control valve assembly with a regeneration valve according to one aspect of the present disclosure.

FIG. 4 is a graph illustrating a command in a first direction and a command in a second direction with an initial command value offset according to one aspect of the present disclosure.

FIG. 5 is a graph illustrating a first side pressure as a function of a second side pressure for a hydraulic function according to one aspect of the present disclosure.

FIG. 6 is a schematic illustration of a fluid source in the form of a dedicated pump configured to supply a control valve assembly according to one aspect of the present disclosure.

FIG. 7 is a schematic illustration of a main control valve configured to supply a control valve assembly according to one aspect of the present disclosure.

FIG. 8 is a schematic illustration of one or more switching valves coupled to a main control valve and configured to supply fluid to a control valve assembly according to one aspect of the present disclosure.

### DETAILED DESCRIPTION

Before any aspects of the present disclosure are explained in detail, it is to be understood that the invention is not limited in its application to the details of construction and the arrangement of components set forth in the following description or illustrated in the following drawings. The invention is capable of other forms and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use aspects of the present disclosure. Various modifications to the illustrated forms will be readily apparent to those skilled in the art, and the generic principles herein can be applied to other aspects and applications without departing from aspects of the disclosure. Thus, aspects of the present disclosure are not intended to be limited to aspects shown, but are to be accorded the widest scope consistent with the principles and features disclosed herein. The following detailed description is to be read with reference to the figures, in which like elements in different figures have like reference numerals. The figures, which are not necessarily to scale, depict selected aspects and are not intended to limit the scope of the present disclosure. Skilled artisans will recognize the examples provided herein have many useful alternatives and fall within the scope of aspects of the invention.

The use of the terms “downstream” and “upstream” herein are terms that indicate direction relative to the flow of a fluid. The term “downstream” corresponds to the direction of fluid flow, while the term “upstream” refers to the direction opposite or against the direction of fluid flow.

The use of the term “motion parameter” herein is a term that corresponds to a kinematic property of a structure. The term “motion parameter” may correspond with one or more of a position, a velocity, and an acceleration of a structure (e.g., a hydraulic function).

Generally, aspects of the present disclosure provide a control valve assembly that is configured to selectively adjust a motion parameter of a hydraulic function. The control valve assembly may provide faster adjustment of a motion parameter due to reduced capacitance of the fluid between the control valve assembly and the hydraulic function. In this regard, some aspects of the present disclosure provide a control valve assembly that may be arranged between a main control valve and the hydraulic function. Arranging the control valve assembly between the main control valve and the hydraulic function, for example, places the control valve assembly closer to the hydraulic function than the main control valve, which inherently reduces the latency associated with supplying fluid to and from the hydraulic function via the main control valve (e.g., due to long hose connections, etc.).

In some aspects, a controller may be provided to control the control valve assembly. The controller may be configured to selectively enable adjustment of the motion parameter of the hydraulic function by the control valve assembly. In some aspects, the adjustment provided by the control valve assembly may be supplemental to control provided by the main control valve. In some aspects, the adjustment provided by the control valve assembly may occur after an initial command from the main control valve. In any case, when it is desired to adjust the motion parameter of the hydraulic function via the control valve assembly, the controller may instruct the control valve assembly to quickly adjust an actual motion parameter of the hydraulic function, for example, to bring the actual motion parameter within a predetermined tolerance of a desired motion parameter. In some aspects, the controller may be configured to instruct the control valve assembly to achieve one or more target pressures of the hydraulic function to adjust the desired motion parameter.

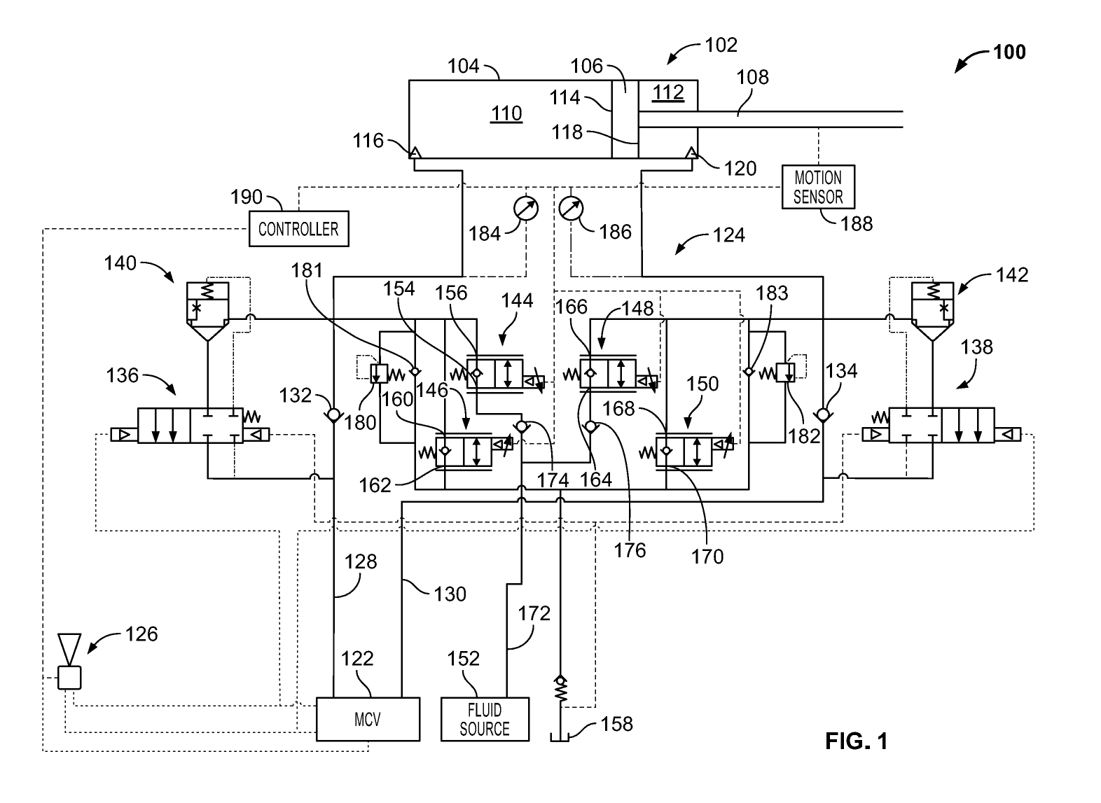

FIG. 1 illustrates one non-limiting example of a hydraulic circuit 100 configured to control a hydraulic function 102 on a mobile machine according to the present disclosure. In some non-limiting examples, the mobile machine may comprise an earth moving machine, such as an excavator, a dozer, a motor grader, a wheel loader, a scraper, and a skid steer. In some non-limiting examples, the hydraulic circuit 100 may be provided on a mobile machine that requires fast and accurate positioning of a component. In the illustrated non-limiting example, the hydraulic function 102 is in the form of a hydraulic actuator. The systems and methods described herein may be applicable to other types of hydraulic functions that require fast and accurate control of a motion parameter. In some non-limiting examples, the hydraulic function 102 may be in the form of a motor.

In the illustrated non-limiting example, the hydraulic function 102 includes a cylinder 104, a piston 106 slidably arranged within the cylinder 104, and a rod 108 coupled to the piston 106 and extending out of an end of the cylinder 104. The cylinder 104 can define a first chamber 110 and a second chamber 112. The first chamber 110 can be enclosed by a first surface 114 of the piston 106 and the cylinder 104. The first chamber 110 can be in fluid communication with a first workport 116 of the hydraulic function 102. The second chamber 112 can be enclosed by a second surface 118 of the piston 106, the rod 108, and the cylinder 104. The second chamber 112 can be in fluid communication with a second workport 120 of the hydraulic function 102. In some non-limiting examples, the hydraulic function 102 may be coupled to a control arm, or boom, on an excavator.

The hydraulic circuit 100 may include a main control valve 122 and a control valve assembly 124. The main control valve 122 may include one or more valves (e.g., spool valves) arranged therein each configured to control the flow of fluid to and from a desired hydraulic function (e.g., travel, rotate, control arm, etc.) on the mobile machine. In the illustrated non-limiting example, the main control valve 122 may be responsive to an input 126 manipulated by an operator, or an automated system. The direction and magnitude that the input 126 is manipulated may correspond with a desired motion parameter of the hydraulic function 102. For example, the desired motion parameter may correspond with one or more of a desired position, a desired velocity, and a desired acceleration of the hydraulic function 102 that is commanded by the manipulation of the input 126.

In the illustrated non-limiting example, a first main passage 128 provides fluid communication between the main control valve 122 and the first workport 116, and a second main passage 130 provides fluid communication between the main control valve 122 and the second workport 120. A first main load check valve 132 may be arranged on the first main passage 128 and can be configured to inhibit fluid flow in a direction from the first workport 116 toward the main control valve 122. A second main load check valve 134 may be arranged on the second main passage 130 and can be configured to inhibit fluid flow in a direction from the second workport 120 toward the main control valve 122. In some non-limiting examples, the main control valve 122 may be supplied with pressurized fluid (e.g., oil) by a main pump (not shown). In some non-limiting examples, the main pump (not shown) may be a pressure compensated pump or a fixed pressure pump.

In the illustrated non-limiting example, the control valve assembly 124 may be arranged in a hose break manifold that may include a first hose break valve 136, a second hose break valve 138, a first low leak check valve 140, and a second low leak check valve 142. In some non-limiting examples, the hose break manifold, and thereby the control valve assembly 124, may be coupled to a non-moving component on the hydraulic function 102 (e.g., the cylinder 104). It should be appreciated that integrating the control valve assembly 124 into a hose break manifold is but one non-limiting example of the present disclosure. In some non-limiting examples, the control valve assembly 124 may be manufactured into its own manifold, or structure, and arranged between the main control valve 122 and the hydraulic function 102. Preferably, the control valve assembly 124 may be arranged as close as possible to the hydraulic function 102 to reduce the capacitance of the fluid flowing between the control valve assembly 124 and the hydraulic function 102. In general, hydraulic fluid is not entirely non-compressible, and hydraulic hoses within a hydraulic circuit have some compliance. The longer the hoses, the more compliant the system and, thus, shorter hoses and smaller fluid volume will stiffen a given hydraulic function. In this way, arranging the control valve assembly 124 closer to the hydraulic function 102 enables adjustments to a motion parameter (e.g., position, velocity, acceleration, etc.) of the hydraulic function 102 with improved response.

In the illustrated non-limiting example, each of the first hose break valve 136 and the second hose break valve 138 is a two-way, two-position valve that may be selectively moved between the two positions by the input 126. For example, the first hose break valve 136 may be normally biased into a closed position where fluid communication is inhibited therethrough. The first hose break valve 136 may be selectively movable from the closed position to an open position where fluid communication is provided therethrough, in response to the input 126 commanding the hydraulic function in a first direction. The second hose break valve 138 may be normally biased into a closed position where fluid communication is inhibited therethrough. The second hose break valve 138 may be selectively movable from the closed position to an open position where fluid communication is provided therethrough, in response to the input 126 commanding the hydraulic function in a second direction opposite to the first direction. Thus, when the hydraulic function 102 is commanded, a corresponding one of the first hose break valve 136 and the second hose break valve 138 moves to the opened position to allow fluid to flow to and from the hydraulic function 102, for example, via the main control valve 122. In this way, for example, the hydraulic circuit 100 is protected against failure modes associated with the control valve assembly 124 and maintains normal operation of the hydraulic circuit 100 (i.e., operation without the control valve assembly 124).

When the input 126 is in a neutral position, the first hose break valve 136 and the second hose break valve 138 may be in the closed position, which isolates the hydraulic function 102 from the main control valve 122. Isolation from the main control valve 122 stiffens the hydraulic function 102 by reducing the volume of fluid holding the hydraulic function 102 in position (i.e., there are components such as flexible hydraulic hoses against which the hydraulic function 102 may “spring”). In this way, for example, control of a motion parameter with the control valve assembly 124 may improve the fidelity of the control.

The first low leak check valve 140 may be arranged between the first workport 116 and the first hose break valve 136 to inhibit fluid flow in a direction from the first workport 116 toward the first hose break valve 136. The second low leak check valve 142 may be arranged between the second workport 120 and the second hose break valve 138 to inhibit fluid flow in a direction from the second workport 120 toward the second hose break valve 138.

In the illustrated non-limiting example, the control valve assembly 124 may include a first supply valve 144, a first return valve 146, a second supply valve 148, and a second return valve 150, and a fluid source 152. The first supply valve 144 may be arranged between the fluid source 152 and the first workport 116 and may include a first supply inlet 154 and a first supply outlet 156. The first supply valve 144 may be configured to selectively provide fluid communication between the fluid source 152 and the first workport 116. For example, the first supply valve 144 may be selectively movable between a closed position where fluid communication is inhibited between the fluid source 152 and the first workport 116, and an open position where fluid communication is provided between the fluid source 152 and the first workport 116. In the illustrated non-limiting example, the first supply valve 144 may be normally biased into the closed position.

The first return valve 146 may be arranged between the first workport 116 and a reservoir 158 and may include a first return inlet 160 and a first return outlet 162. The first return valve 146 may be configured to selectively provide fluid communication between the first workport 116 and the reservoir 158. For example, the first return valve 146 may be selectively movable between a closed position where fluid communication is inhibited between the first workport 116 and the reservoir 158, and an open position where fluid communication is provided between the first workport 116 and the reservoir 158. In the illustrated non-limiting example, the first return valve 146 may be normally biased into the closed position.

The second supply valve 148 may be arranged between the fluid source 152 and the second workport 120 and may include a second supply inlet 164 and a second supply outlet 166. The second supply valve 148 may be configured to selectively provide fluid communication between the fluid source 152 and the second workport 120. For example, the second supply valve 148 may be selectively movable between a closed position where fluid communication is inhibited between the fluid source 152 and the second workport 120, and an open position where fluid communication is provided between the fluid source 152 and the second workport 120. In the illustrated non-limiting example, the second supply valve 148 may be normally biased into the closed position.

The second return valve 150 may be arranged between the second workport 120 and the reservoir 158 and may include a second return inlet 168 and a second return outlet 170. The second return valve 150 may be configured to selectively provide fluid communication between the second workport 120 and the reservoir 158. For example, the second return valve 150 may be selectively movable between a closed position where fluid communication is inhibited between the second workport 120 and the reservoir 158, and an open position where fluid communication is provided between the second workport 120 and the reservoir 158. In the illustrated non-limiting example, the second return valve 150 may be normally biased into the closed position.

A supply passage 172 may extend from the fluid source 152 to provide pressurized fluid to the first supply valve 144 and the second supply valve 148. The supply passage 172 is in fluid communication with the first supply inlet 154 and the second supply inlet 164. In the illustrated non-limiting example, a first load check valve 174 may be arranged between the first supply valve 144 and the fluid source 152, and a second load check valve 176 may be arranged between the second supply valve 148 and the fluid source 152. The first load check valve 174 may be configured to inhibit fluid flow in a direction from the first supply valve 144 toward the fluid source 152, and the second load check valve 176 may be configured to inhibit fluid flow in a direction from the second supply valve 148 toward the fluid source 152.

A first pressure relief valve 180 may be arranged between the first workport 116 and the reservoir 158, and may be configured to provide fluid communication between the first workport 116 and the reservoir 158 when a pressure at the first workport 116 exceeds a predetermined value. A first anti-void check valve 181 may be arranged between the first workport 116 and the reservoir 158 and inhibit fluid flow in a direction from the first workport 116 toward the reservoir 158. The first pressure relief valve 180 may bypass around the first anti-void check valve 181. A second pressure relief valve 182 may be arranged between the second workport 120 and the reservoir 158, and may be configured to provide fluid communication between the second workport 120 and the reservoir 158 when a pressure at the second workport 120 exceeds a predetermined value. A second anti-void check valve 183 may be arranged between the second workport 120 and the reservoir 158 and inhibit fluid flow in a direction from the second workport 120 toward the reservoir 158. The second pressure relief valve 182 may bypass around the second anti-void check valve 183. In the event of an over-running load, the control system may allow the hydraulic function 102 to move faster than the supply can supply fluid to the expanding chamber. The first and second anti-void check valves 181 and 183 may allow additional fluid into that chamber to prevent voiding (which would significantly reduce the stiffness of the circuit).

In the illustrated non-limiting example, a first pressure sensor 184 may be configured to measure a pressure at the first workport 116, a second pressure sensor 186 may be configured to measure a pressure at the second workport 120, and a motion sensor 188 may be configured to measure a motion parameter of the hydraulic function 102. In some non-limiting examples, the motion sensor 188 may be configured to measure or calculate a position of the hydraulic function 102, from which velocity and acceleration may be derived. In some non-limiting examples, the motion sensor 188 may be coupled to component on the mobile machine (e.g., a bucket) that is geometrically linked to the hydraulic function 102. A known geometric relationship may be leveraged to determine a position of one or more functions on the mobile machine. In this way, for example, a desired motion parameter for a given function may be determined based on an actual motion parameter, without necessarily sensing each individual function. In some non-limiting examples, the motion sensor 188 may be an inertial measurement unit configured to determine a motion parameter (e.g., acceleration) from which all of the motion parameters may be derived. In some non-limiting examples, the motion sensor 188 may be a gyroscope sensor configured to determine a change in orientation. In some non-limiting examples, the motion sensor 188 may be a GPS configured to determine global position. In some non-limiting examples, the motion sensor 188 may be an LVDT configured to determine a position.

A controller 190 may be in communication with the first pressure sensor 184, the second pressure sensor 186, the motion sensor 188, the first supply valve 144, the first return valve 146, the second supply valve 148, and the second return valve 150. In some non-limiting examples, the controller 190 may be in communication with the input 126. In some non-limiting examples, the controller 190 may be in communication with the fluid source 152. In some non-limiting examples, the controller 190 may be in communication with the main control valve 122 and may be configured to control the one or more valves arranged therein. In some non-limiting examples, the controller 190 may be separate from a main controller (not shown) that is configured to control the operation of the main control valve 122. In some non-limiting examples, the controller 190 may be in communication with the main controller (not shown).

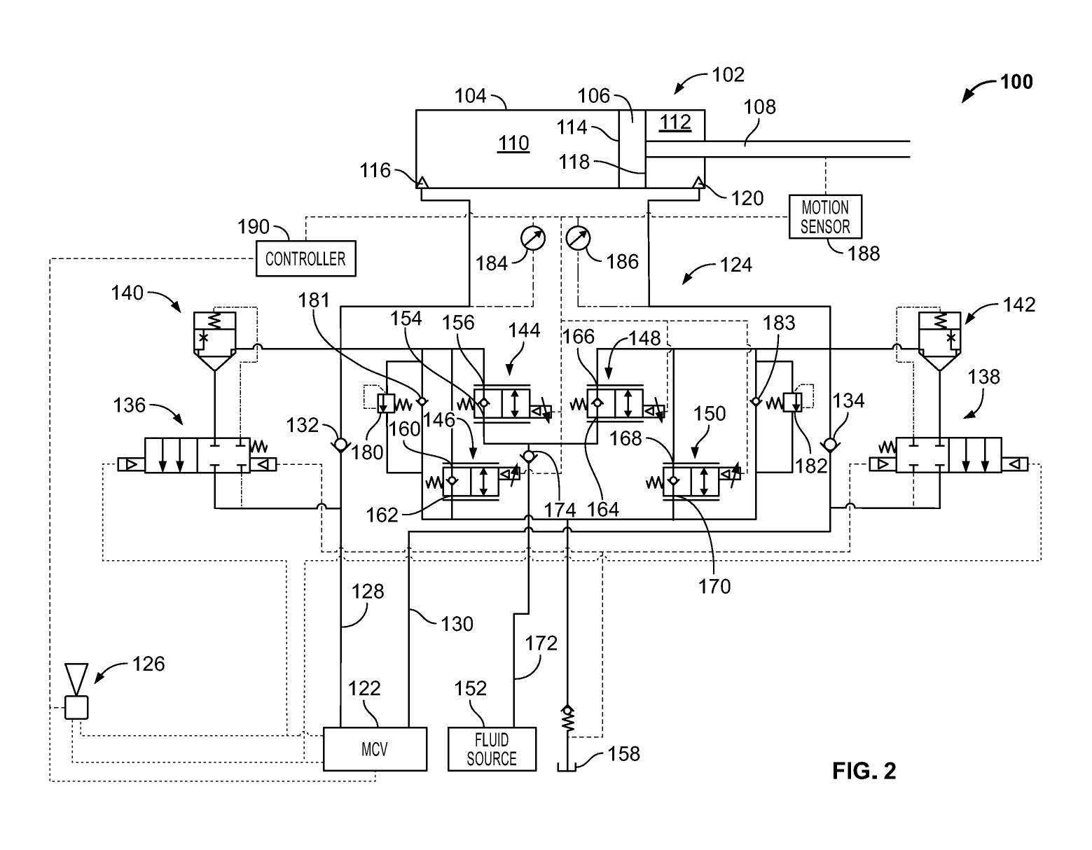

FIG. 2 illustrates another non-limiting example of the hydraulic circuit 100 according to the present disclosure. As illustrated in FIG. 2, the hydraulic circuit 100 may not include the second load check valve 176 and the first supply inlet 154 of the first supply valve 144 may be directly connected to the second supply inlet 164 of the second supply valve 148. In this way, for example, selective regeneration of fluid between the first workport 116 and the second workport 120 may be enabled.

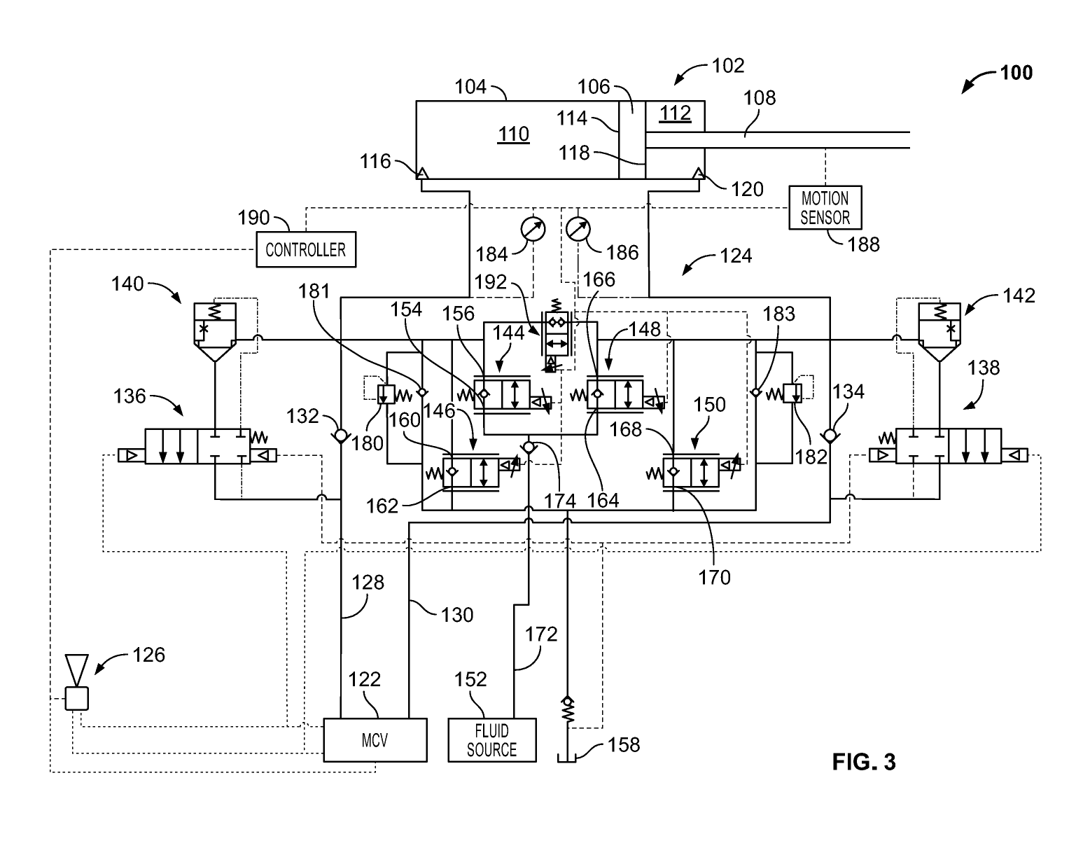

FIG. 3 illustrates another non-limiting example of the hydraulic circuit 100 according to the present disclosure. As illustrated in FIG. 3, the hydraulic circuit 100 of FIG. 3 may be similar to FIG. 2 with the addition of a regeneration valve 192. The regeneration valve 192 may be arranged to bypass regeneration path through the first supply valve 144 and the second supply valve 148, and may be configured to selectively enable regeneration of fluid between the first workport 116 and the second workport 120. The regeneration valve 192 may be in communication with the controller 190 and may be selectively movable between a first regeneration position where fluid communication is inhibited through the regeneration valve 192 and a second regeneration position where fluid communication is provided through the regeneration valve 192. In the illustrated non-limiting example, the regeneration valve 192 may be normally biased into the first regeneration position. In the second generation position, the regeneration valve 192 may directly connect the first workport 116 and the second workport 120 to enable fast responses when controlling a motion parameter of the hydraulic function 102.

Various operating strategies for the hydraulic circuit 100 will be described with reference to FIGS. 1-5. In operation, the control valve assembly 124 may be controlled, via the controller 190, using one or more strategies. In general, the hydraulic function 102 may be operated in a mode where the control valve assembly 124 is active and a mode where the control valve assembly 124 is inactive. Typically, when the control valve assembly 124 is inactive, the main control valve 122 may facilitate the operation of the hydraulic function 102 to perform desired tasks on the mobile machine. As described herein, the control valve assembly 124 provides fast response control of a motion parameter of the hydraulic function 102, when compared to the main control valve 122. Thus, the control valve assembly 124 may be activated simultaneously with the main control valve 122 and/or separate from the main control valve 122 to adjust or maintain a desired motion parameter of the hydraulic function 102. In some non-limiting examples, the control valve assembly 124 may enable “fine tuning” of a desired motion parameter of the hydraulic function 102 before, during, or after a “bulk” motion by the main control valve 122. In some non-limiting examples, the fast response control provided by the control valve assembly 124 may enable precise and accurate automated control of the hydraulic function 102.

In one non-limiting example of operation, the controller 190 may be configured to determine if an actual motion parameter of the hydraulic function 102 is different than or not within a predetermined tolerance of a desired motion parameter based on the measurement of the motion sensor 188. For example, the main control valve 122 may initially attempt to achieve the desired motion parameter of the hydraulic function 102. If the controller 190 determines that the actual motion parameter of the hydraulic function 102 measured by the motion sensor 188 is different than or not within a predetermined tolerance of the desired motion parameter, the controller 190 may be configured to move at least one of the first supply valve 144, the first return valve 146, the second supply valve 148, and the second return valve 150 to adjust the actual motion parameter of the hydraulic function 102. In this way, the control valve assembly 124 may leverage the quick response control thereof to compensate for the difference between the actual motion parameter and the desired motion parameter and/or bring the actual motion parameter within a predetermined tolerance of the desired motion parameter.

In some non-limiting examples, the control valve assembly 124 may be configured to manipulate the hydraulic function 102 to control a motion parameter thereof by achieving target pressures at each of the first workport 116 and the second workport 120, which may be determined or set by the controller 190. The target pressures of the first workport 116 and the second workport 120 may correspond with a desired motion parameter of the hydraulic function 102. In some non-limiting examples, the target pressure at the first workport 116 and the second workport 120 may be based at least partially on the load on the hydraulic function 102 and the known ratio between the pressure areas of the first chamber 110 and the second chamber 112. In any case, for a given state of the hydraulic function 102, target pressures may be determined by the controller 190 that correspond with a desired motion parameter of the hydraulic function 102.

To facilitate achieving the target pressures at the first workport 116 and the second workport 120 with the control valve assembly 124, the controller 190 may be configured to move at least one of the first supply valve 144 and the first return valve 146 to achieve a pressure at the first workport 116 within a predetermined tolerance of a target first workport pressure. Alternatively or additionally, the controller 190 may be configured to move at least one of the second supply valve 148 and the second return valve 150 to achieve a pressure at the second workport 120 within a predetermined tolerance of a target second workport pressure. For example, the first supply valve 144 may be moved by the controller 190 from the closed position to the open position to provide fluid from the fluid source 152 to the first workport 116 and increase a pressure at the first workport 116. Alternatively, the first return valve 146 may be moved by the controller 190 from the closed position to the open position to provide fluid communication between the first workport 116 and the reservoir 158 and decrease a pressure at the first workport 116. The second supply valve 148 and the second return valve 150 may by similarly moved by the controller 190 to control the pressure at the second workport 120.

In some non-limiting examples, the controller 190 may be configured to determine the target pressures at the first workport 116 and the second workport 120 to ensure that the pressure at the first workport 116 and the second workport 120 is sufficient to store enough energy to react to external forces on the hydraulic function 102. In this way, for example, the target pressures at the first workport 116 and the second workport 120 may be determined to inhibit a non-loaded side of the hydraulic function 102 from cavitating and/or drawing oil from the reservoir 158 into the hydraulic function 102.

In some non-limiting examples, the control valve assembly 124 may be activated to control the actual motion parameter of the hydraulic function 102 when there is no command from the input 126 to the hydraulic function 102. That is, the control valve assembly 124 may be supplemental to the main control valve 122 and enable fast “fine tuning” of the actual motion parameter of the hydraulic function 102.

In some non-limiting examples of operation, the controller 190 may be configured to selectively apply an initial command to each of the first supply valve 144, the first return valve 146, the second supply valve 148, and the second return valve 150. In this way, for example, latency of the control valve assembly 124 may be mitigated. In some non-limiting examples, when the initial command is provided by the controller 190, each of the first supply valve 144, the first return valve 146, the second supply valve 148, and the second return valve 150 may partially move toward the open position and into an intermediate position. In some non-limiting examples, when each of the first supply valve 144, the first return valve 146, the second supply valve 148, and the second return valve 150 is in the intermediate position, fluid flow is inhibited through each of the first supply valve 144, the first return valve 146, the second supply valve 148, and the second return valve 150.

In some non-limiting examples, the initial command may be added to each direction of command and then the valve opening commands may be calculated accordingly. For example, an output command to one or more of the first supply valve 144, the first return valve 146, the second supply valve 148, and the second return valve 150 in a first direction may be calculated by determining if an input command in the first direction is less than zero. If the input command in the first direction is less than zero, the output command to the one or more of the first supply valve 144, the first return valve 146, the second supply valve 148, and the second return valve 150 may be the maximum of the sum of initial command value and the input command and zero. If the input command in the first direction is not less than zero, the output command to the one or more of the first supply valve 144, the first return valve 146, the second supply valve 148, and the second return valve 150 may be the maximum of the initial command value and the input command. An output command to the one or more of the first supply valve 144, the first return valve 146, the second supply valve 148, and the second return valve 150 in a second direction opposite to the first direction may be calculated by determining if an input command in the second direction is less than zero. If the input command in the second direction is less than zero, the output command to the one or more of the first supply valve 144, the first return valve 146, the second supply valve 148, and the second return valve 150 may be the minimum of the negative value of the initial command and the input command. If the input command in the second direction is not less than zero, the output command to the one or more of the first supply valve 144, the first return valve 146, the second supply valve 148, and the second return valve 150 may be the minimum of the different between the velocity command and the initial command value and zero.

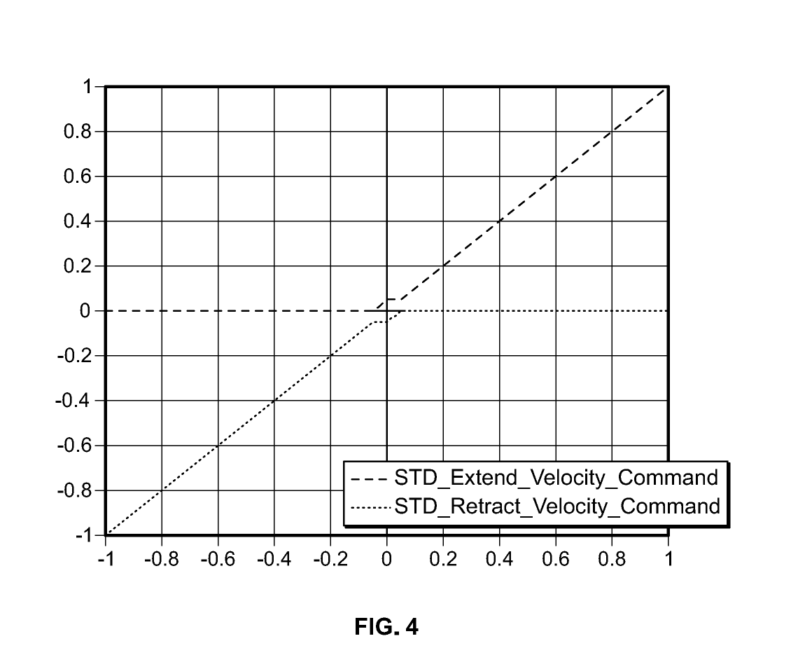

This output command calculation described above for the first and the second directions is illustrated in FIG. 4 for the non-limiting initial command value of 0.05. As illustrated in FIG. 4, the initial command value may ensure that the one or more of the first supply valve 144, the first return valve 146, the second supply valve 148, and the second return valve 150 have a modified command applied thereto to keep those valves in an intermediate position (i.e., on the brink of opening, almost or even slightly open), when a magnitude of the command is small. In some non-limiting examples, if the input command is in a first, or positive, direction, then the first supply valve 144 and second return valve 150 may be energized. Likewise, with an input command in a second, or negative, direction, the second supply valve 148 and first return valve 146 may be energized. Thus, when the controller 190 has a small command in either the first direction or the second direction, a change in command could go either way, and by keeping all the valves 144, 146, 148, and 150 in the intermediate position, the response will be quicker. FIG. 4 illustrate this with the X-axis being the command the controller 190 determines is necessary to meet the motion control targets, and the Y-axis is an “apparent” or “effective” or “modified” command use to generate valves commands.

In some non-limiting examples, the control valve assembly 124 may be variable and responsive to the loads on the hydraulic function 102, so as the work activity of the mobile machine changes the pressure provided by the fluid source 152 may be adapted accordingly. With this variable control, a pressure set point for the fluid source 152 may be controlled with much higher differential pressure minimums on the first supply valve 144, the first return valve 146, the second supply valve 148, and the second return valve 150, when compared to conventional pressure differential minimums. In conventional systems, the differential pressure targets may be 15 bar or lower. For the control valve assembly 124, the differential pressure minimums may be much higher and possibly as high as approximately 50 bar to approximately 75 bar. In addition to using the differential pressure minimum, the control valve assembly 124 may define a minimum pressure threshold to ensure that the fluid source 152 outlet pressure is charged sufficiently for initial motion. This minimum pressure threshold may be in the range of approximately 150 bar to approximately 200 bar.

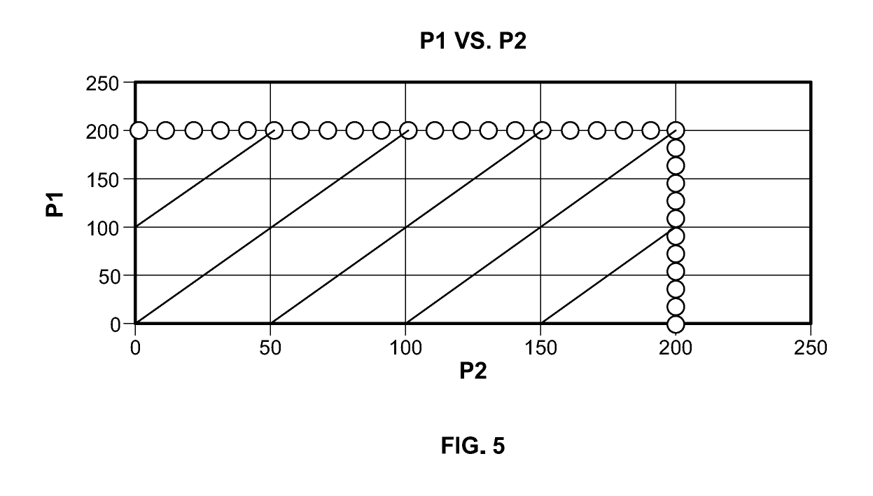

In general, a force acting on the hydraulic function 102 may be calculated as a function of the pressures at the first workport 116 and the second workport 120 and the known known ratio between the pressure areas of the first chamber 110 and the second chamber 112. Since the ratio between the pressure areas of the hydraulic function 102 is a constant, the force may be proportional to the pressure in the first workport 116 minus the pressure in the second workport 120 divided by the ratio of pressure areas. FIG. 5 illustrates one non-limiting example of a graph including a plurality of constant force lines that correspond with various pressures in the first workport 116 and the second workport 120. Thus, for a given pressure at one of the first workport 116 and the second workport 120, a pressure may be determined at the other of the first workport 116 and the second workport 120 to correspond with a desired motion parameter of the hydraulic function 102. This strategy may be simplified by fixing the pressure at one of the first workport 116 and the second workport 120, which may require the pressure at one of the first workport 116 and the second workport 120 to be adjusted by the control valve assembly 124. For example, the control valve assembly 124 may be configured to control a motion parameter of the hydraulic function 102 by setting a pressure at one of the first and second workports 116 and 120 to a predetermined system pressure and controlling a pressure at the other of the first and second workports 116 and 120 to a predetermined pressure below the predetermined system pressure.

In the illustrated non-limiting example of FIG. 5, the predetermined system pressure is set to 200 bar. In one non-limiting example, the controller 190 may be configured to instruct one of the first supply valve 144 and the second supply valve 148 to move to a fully open position and pressurize a corresponding one of the first workport 116 and the second workport 120 to the predetermined system pressure via connection to the fluid source 152. With one of the first workport 116 and the second workport 120 at the predetermined system pressure, a pressure at the other of the first workport 116 and the second workport 120 may be determined to correspond with a desired motion parameter of the hydraulic function. The controller 190 may be configured to control a pressure in the other of the first workport 116 and the second workport 120 to a predetermined pressure below the predetermined system pressure via at least one of the first supply valve 144, the first return valve 146, the second supply valve 148, and the second return valve 150. For example, if the first workport 116 is at the predetermined system pressure and it is desired to adjust a motion parameter of the hydraulic function 102 in a first direction, the controller 190 may move the second return valve 150 to the open position and thereby place the second workport 120 in fluid communication with the reservoir 158, which is at a lower pressure than the second workport 120. If the first workport 116 is at the predetermined system pressure and it is desired to adjust a motion parameter of the hydraulic function 102 in a second direction opposite to the first direction, the controller 190 may move the second supply valve 148 to the open position to provide regeneration that allows fluid to flow from the first workport 116 to the second workport 120 (see, e.g., FIG. 2). Thus, the controller 190 may need to move one of the second supply valve 148 and the second return valve 150, while the first supply valve 144 remains open, to control a motion parameter of the hydraulic function 102. In this way, the control strategy of the control valve assembly 124 may be simplified and increase efficiency.

In some non-limiting examples, implementing the predetermined system pressure approached described above, the regeneration valve 192 (see, e.g., FIG. 3) may be moved to facilitate the control of the pressure at one of the first workport 116 and the second workport 120. That is, rather than opening one of the first supply valve 144 and the second supply valve 148 to provide regeneration, the regeneration valve 192 may be moved to the second regeneration position by the controller 190 to connect the first workport 116 to the second workport 120 and allow regeneration (e.g., due to backpressure and ratio of pressure areas or due to the pressure ratio between the workports). In some non-limiting examples, the regeneration valve 192 enables the control valve assembly 124 to control a motion parameter of the hydraulic function 102 quickly at high loads.

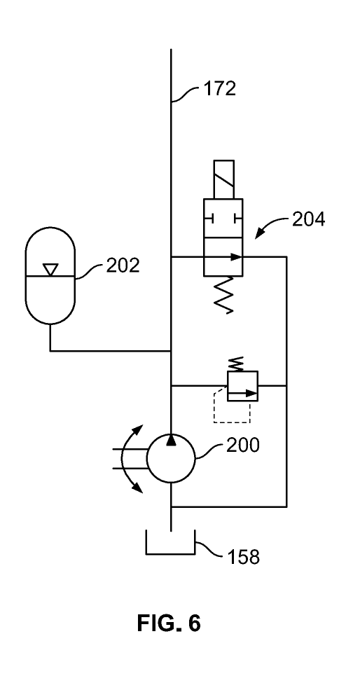

FIG. 6 illustrates one non-limiting example of the fluid source 152 in the form of a dedicated pump 200 configured to draw fluid from the reservoir 158 and furnish the fluid under increased pressure to the supply passage 172. The dedicated pump 200 may be separate from the main pump (not shown) configured to supply the main control valve 122 (see, e.g., FIGS. 1-3). The dedicated pump 200 may be a variable displacement, pressure compensated pump, or a gear pump with a pressure relief valve (e.g., unloader). An accumulator 202 may be arranged downstream of the dedicated pump 200 to allow momentary flow in excess of the capacity of the dedicated pump 200. A drain valve 204 may be configured to provide fluid communication between the supply passage 172 at a location slightly downstream of the accumulator 202 and the reservoir 158 to enable the pressure to be dumped to the reservoir 158 when the control valve assembly 124 (see, e.g., FIGS. 1-3) is not activated.

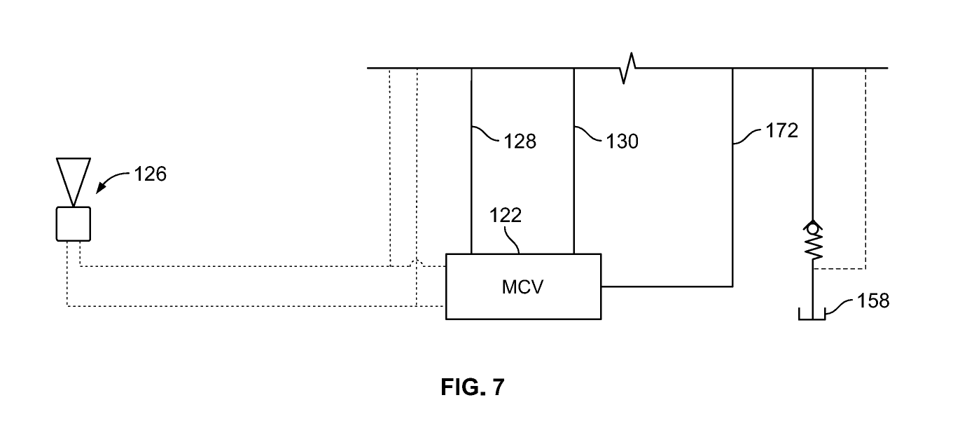

FIG. 7 illustrates another non-limiting example of the fluid source 152 where the fluid source 152 comes from the main control valve 122. As illustrated in FIG. 7, the supply passage 172 may be in fluid communication with the main control valve 122, which is supplied with pressurized fluid by the main pump (not shown). In some non-limiting examples, the main pump (not shown) may be a fixed displacement or a variable displacement pump. In some non-limiting examples, the main pump (not shown) may be pressure compensated to provide a fixed pressure. In some non-limiting examples, the supply passage 172 may be in fluid communication with a section of the main control valve 122 that corresponds with the same hydraulic function configured to be manipulated by the control valve assembly 124 (see, e.g., FIGS. 1-3). In some non-limiting examples, the supply passage 172 may be in fluid communication with a section of the main control valve 122 that corresponds with a different hydraulic function than the hydraulic function configured to be manipulated by the control valve assembly 124 (see, e.g., FIGS. 1-3).

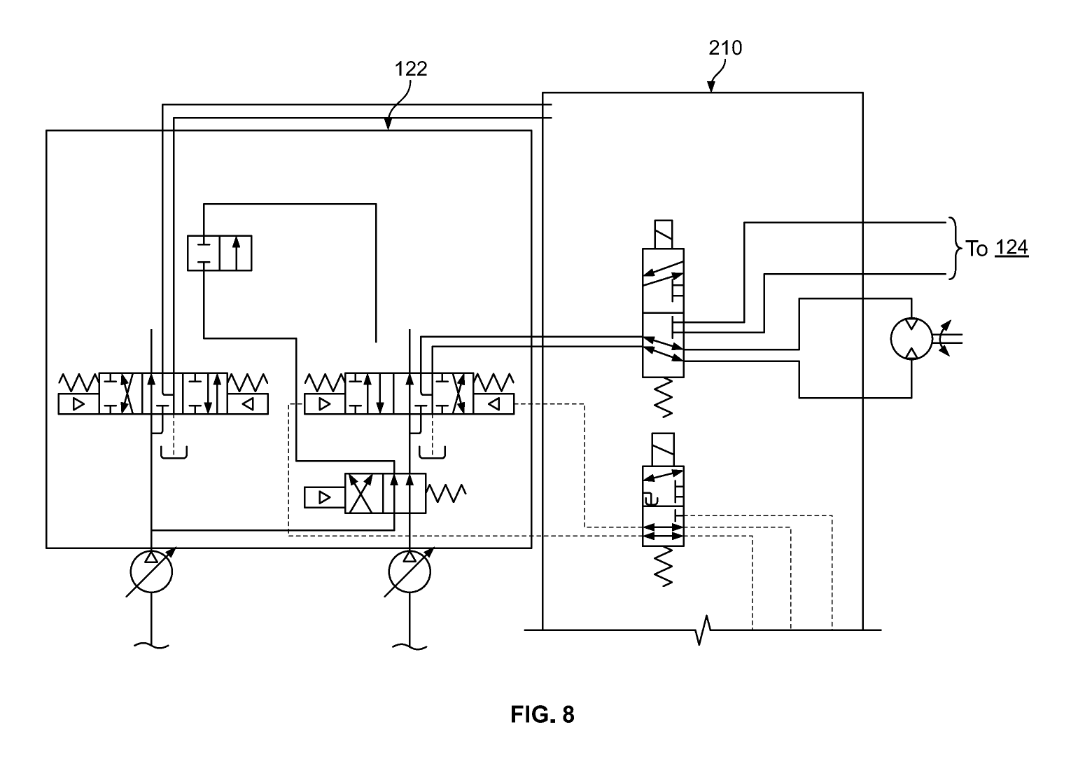

FIG. 8 illustrates another non-limiting example of the fluid source 152 where the fluid source 152 comes from the main pump (not shown) supplying the main control valve 122. One or more switching valves 210 may be added to one or more sections of the main control valve 122 that correspond with a given function on the mobile machine. The switching valves 210 may be configured to selectively provide pressurized fluid from the main pump (not shown) to either a hydraulic function on the mobile machine or at least one of the first supply valve 144 and the second supply valve 148 via the supply passage 172 (see, e.g., FIGS. 1-3). In some non-limiting examples, the switching valves 210 may be configured to provide fluid from the main pump (not shown) to the hydraulic function when the hydraulic function is commanded and to the supply passage 172 when the hydraulic function is not commanded. In some non-limiting examples, the hydraulic function coupled to the switching valve 210 may be a hydraulic function other than the hydraulic function configured to be manipulated by the control valve assembly 124 (see, e.g., FIGS. 1-3).

Within this specification aspects of the present disclosure have been described in a way which enables a clear and concise specification to be written, but it is intended and will be appreciated that aspects of the present disclosure may be variously combined or separated without parting from the invention. For example, it will be appreciated that all preferred features described herein are applicable to all aspects of the invention described herein.

Thus, while the invention has been described in connection with particular aspects and examples, the invention is not necessarily so limited, and that numerous other aspects, examples, uses, modifications and departures from the aspects, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

We claim:

1. A control valve assembly arranged between a main control valve and a hydraulic function on a mobile machine, the hydraulic function including a first workport and a second workport, the control valve assembly comprising:
a fluid source;
a first supply valve configured to selectively provide fluid communication between the fluid source and the first workport;
a first return valve configured to selectively provide fluid communication between the first workport and a reservoir;
a second supply valve configured to selectively provide fluid communication between the fluid source and the second workport;
a second return valve configured to selectively provide fluid communication between the second workport and the reservoir;
a motion sensor configured to determine a motion parameter of the hydraulic function; and
a controller in communication with the first supply valve, the first return valve, the second supply valve, the second return valve, and the motion sensor, the controller being configured to:
determine if an actual motion parameter of the hydraulic function is different than a desired motion parameter based on the determination of the motion sensor, and
selectively move at least one of the first supply valve, the first return valve, the second supply valve, and the second return valve to adjust the actual motion parameter of the hydraulic function and compensate for a difference between the actual motion parameter and the desired motion parameter.

2. The control valve assembly of claim 1, wherein the first supply valve is selectively movable between a closed position where fluid communication is inhibited between the fluid source and the first workport and an open position where fluid communication is provided between the fluid source and the first workport;
wherein the first return valve is selectively movable between a closed position where fluid communication is inhibited between the first workport and a reservoir and an open position where fluid communication is provided between the first workport and the reservoir;
wherein the second supply valve is selectively movable between a closed position where fluid communication is inhibited between the fluid source and the second workport and an open position where fluid communication is provided between the fluid source and the second workport;
wherein the second return valve is selectively movable between a closed position where fluid communication is inhibited between the second workport and a reservoir and an open position where fluid communication is provided between the second workport and the reservoir.

3. The control valve assembly of claim 1, further comprising a load check valve arranged between the fluid source and at least one of the first supply valve and the second supply valve, the load check valve configured to inhibit fluid flow in a direction from the at least one of the first supply valve and the second supply valve toward the fluid source.

4. The control valve assembly of claim 1, wherein a first supply inlet of the first supply valve is in fluid communication with a first supply inlet of the second supply valve to enable regeneration of fluid between the first workport and the second workport.

5. The control valve assembly of claim 1, further comprising a regeneration valve arranged to bypass the first supply valve and the second supply valve and selectively enable regeneration of fluid between the first workport and the second workport.

6. The control valve assembly of claim 5, wherein the regeneration valve is in communication with the controller and is selectively movable between a first regeneration position where fluid communication is inhibited through the regeneration valve and a second regeneration position where fluid communication is provided through the regeneration valve.

7. The control valve assembly of claim 1, further comprising a first load check valve arranged between the first supply valve and the fluid source and configured to inhibit fluid flow in a direction from the first supply valve toward the fluid source, and a second load check valve arranged between the second supply valve and the fluid source and configured to inhibit fluid flow in a direction from the second supply valve toward the fluid source.

8. The control valve assembly of claim 1, wherein the motion parameter is a position of the hydraulic function.

9. The control valve assembly of claim 1, wherein the motion parameter is an acceleration of the hydraulic function.

10. The control valve assembly of claim 1, wherein the fluid source is in the form of a dedicated pump.

11. The control valve assembly of claim 10, further comprising an accumulator arranged downstream of the dedicated pump.

12. The control valve assembly of claim 1, wherein the fluid source is configured to receive pressurized fluid from the main control valve.

13. The control valve assembly of claim 12, further comprising one or more switching valves configured to selectively provide pressurized fluid to either another hydraulic function on the mobile machine or at least one of the first supply valve and the second supply valve.

14. The control valve assembly of claim 1, wherein the controller is configured to selectively apply an initial command to each of the first supply valve, the first return valve, the second supply valve, and the second return valve, the initial command partially biasing each of the first supply valve, the first return valve, the second supply valve, and the second return valve toward an open position and into an intermediate position.

15. The control valve assembly of claim 14, wherein, when each of the first supply valve, the first return valve, the second supply valve, and the second return valve is in the intermediate position, fluid flow is inhibited through each of the first supply valve, the first return valve, the second supply valve, and the second return valve.

16. A control valve assembly arranged between a main control valve and a hydraulic function on a mobile machine, the hydraulic function including a first workport and a second workport, the control valve assembly comprising:
a fluid source;
a first supply valve configured to selectively provide fluid communication between the fluid source and the first workport;
a first return valve configured to selectively provide fluid communication between the first workport and a reservoir;
a second supply valve configured to selectively provide fluid communication between the fluid source and the second workport;
a second return valve configured to selectively provide fluid communication between the second workport and the reservoir;
a motion sensor configured to determine a motion parameter of the hydraulic function;
a first pressure sensor configured to measure a pressure at the first workport;
a second pressure sensor configured to measure a pressure at the second workport; and
a controller in communication with the first supply valve, the first return valve, the second supply valve, the second return valve, the first pressure sensor, the second pressure sensor, and the motion sensor, the controller being configured to:
move at least one of the first supply valve and the first return valve to achieve a pressure at the first workport within a predetermined tolerance of a target first workport pressure,
move at least one of the second supply valve and the second return valve to achieve a pressure at the second workport within a predetermined tolerance of a target second workport pressure, the target first pressure and the target second pressure corresponding with a desired motion parameter of the hydraulic function.

17. The control valve assembly of claim 16, wherein the target first workport pressure is a predetermined system pressure and the controller is configured to instruct one of the first supply valve and the second supply valve to pressurize a corresponding one of the first workport and the second workport to the predetermined system pressure via the fluid source.

18. The control valve assembly of claim 17, wherein the target second pressure is a predetermined pressure below the predetermined system pressure and the controller is configured to control a pressure at the other of the first workport and the second workport to the predetermined pressure via at least one of the first supply valve, the first return valve, the second supply valve, and the second return valve, the predetermined pressure corresponding with a desired motion parameter of the hydraulic function.

19. The control valve assembly of claim 16, wherein the controller is configured to selectively apply an initial command to each of the first supply valve, the first return valve, the second supply valve, and the second return valve, the initial command partially biasing each of the first supply valve, the first return valve, the second supply valve, and the second return valve toward an open position and into an intermediate position.

20. The control valve assembly of claim 19, wherein, when each of the first supply valve, the first return valve, the second supply valve, and the second return valve is in the intermediate position, fluid flow is inhibited through each of the first supply valve, the first return valve, the second supply valve, and the second return valve.
